(19) United States
(12) Patent Application Publication
(10) Pub. No.: US 2011/0173152 A1
(43) Pub. Date: Jul. 14, 2011

(54) Method and device for detecting the On and Off states of a Parkinson patient

(75) Inventors: Manuel Alejandro RODRÍGUEZ MOLINERO, Sant Pere de Ribes (ES); Joan Cabestany Moncusi, Vilanova i la Geltru (ES); David Andrés Pérez Martínez, Madrid (ES); Albert Samà Monsonís, Cornella de Llobregat (ES); César Pavel Gálvez Barrón, Vilanova i la Geltru (ES); Andreu Catalá Mallofré, Vilanova i la Geltru (ES); Cecilio Angulo Bahón, Barcelona (ES); Carlos Pérez López, Vilanova i la Geltru (ES); Jaime Romagosa Cabús, Cunit (ES)

(73) Assignees: FUNDACIO PRIVADA HOSPITAL COMARCAL DE SANT ANTONI ABAT DE VILANOVA I LA GELTRU, Barcelona (ES); UNIVERSITAT POLITECNICA DE CATALUNYA, Barcelona (ES)

(21) Appl. No.: 12/684,813

(22) Filed: Jan. 8, 2010

(51) Int. Cl. G06N 5/02

(52) U.S. Cl. 706/54

(57) ABSTRACT

A method for detecting the on and off states of a Parkinson patient, including obtaining inertial data from a patient and verifying if the patient is in an on or off state by using a transformation of the obtained inertial data which uses a model derived from a set of stored data referred to patients in on state and patients in off state.

### FIELD OF THE INVENTION

The present invention relates to a method or detecting the On and Off states of a Parkinson patient.

The invention also relates to a digital detector and a computer program for detecting the On and Off states of a Parkinson patient, and a method, digital detector and computer program for predicting the onset of an On and Off states of a Parkinson patient.

Furthermore, the invention also relates to a device for injecting a pharmaceutical compound in a Parkinson patient, comprising a digital detector for detecting the On and Off states of a Parkinson patient, and a device for injecting a pharmaceutical compound in a Parkinson patient, comprising a digital detector for predicting the onset of an On and Off states of a Parkinson patient

### BACKGROUND ART

Several systems for infusing pharmaceutical compounds have been developed in recent years, some of which relieve the patient of having to inject himself the compound a plurality of times during the day. More specifically, an automatic or preprogrammed infusion (constant or not) has been found to be useful in cases of a patient, such as a Parkinson patient, needing several infusions during the day. This way, pre-programming the infusions according to a predetermined schedule allows the patient to having to remember the times of the day to inject himself the compound, and therefore normalizing his day to day life.

Also, a further improvement on the infusion device field is a system or device for infusing a pharmaceutical compound depending on an activity status of the patient. This may be relevant when, as in Parkinson patients, the amount of pharmaceutical compound is related in some manner to the activity or movement status of the patient. Such an example might be the one described described in patent application number WO2008/117226, which refers, according to a specific embodiment of the invention, to a system comprising a movement sensor and an infusion pump, wherein a controller monitorizes signals from the movement sensor and, based on an activity status of a Parkinson patient (which corresponds to a movement of the patient, such as tremor or other unspecified ones), determines a quantity of pharmaceutical compound to be injected.

However, the normal activity of a patient, being for example, walking, running or performing a stressful action, may not directly indicate that the patient needs more or less infusion of the pharmaceutical compound, and it may not be needed to infuse the compound whenever such an activity is detected, thus wearing out the effects of the compound on the treatment of the disease in long term.

Therefore, an optimized method for infusing a quantity of a pharmaceutical compound is needed, in order to regulate the infusion of the Parkinson disease treatment accordingly to the patient status regarding this disease.

### SUMMARY OF THE INVENTION

It is an object of the present invention to provide a system and method for detecting the On and Off states of a Parkinson patient, from obtained inertial data from a Parkinson patient.

This is achieved by providing, according to a first aspect of the invention, a method for detecting the On and Off states of a Parkinson patient, the method comprising:
Obtaining inertial data from a patient;
Verifying if the patient is in an On or Off state, by using a transformation of the obtained inertial data which uses a model derived from a set of stored data referred to patients in On state and patients in Off state.

An On state of the patient is an status wherein the patient is not affected by the effects of the Parkinson disease, and therefore lower quantity of infused compound is needed, and an Off state of the patient is an status wherein the patient may be affected by the effects of Parkinson disease, which may be, for example, a clumsy behaviour or awkward movement, paralysis, having sudden falls, and, the most known effect but not the most common, tremors. Therefore, an Off state may not only be detected by a specific movement or quantity of movement, but several behaviours or kinds of movements which indicate that the patient is actually in an Off state.

This way, by using the above method a detection of the state of a patient is performed, using stored data which corresponds to previous knowledge of the behaviour of a patient while being in On or Off state. Also, the model may be useful for any patient or an specific one, depending on the set of stored data used: if the set of stored data corresponds to the same patient, the model will be a personalized one for that specific patient. In an analog way, if a plurality of patients are used to obtain the set of stored data, the model will be a generalization of several patients, and therefore useful for several different patients.

The inertial data may be obtained, for example, from a movement sensor, and more specifically, an accelerometer, which provides three signals corresponding to the three dimensional components of the instant acceleration.

Also, said inertial data may be provided in the form of a matrix of data, and the transformation applied to it may be a mathematical calculation of said matrix of data with the model, said model derived from a set of stored data.

According to a preferred embodiment, the verification of if the patient is in an On or Off state is performed when the patient is moving.

A typical motion of the patient is when the patient is walking, and a detection of said movement, and specifically walking, may be performed by recognizing a pattern in the signals coming from a movement sensor. Also, this pattern recognition may be performed by obtaining inertial data of the patient and verifying if the patient is walking.

This verification may be performed, for example, by using a further second transformation of the obtained inertial data, the second transformation using a movement model derived from a further second set of stored data referred to moving patients and non moving patients (or, specifically, walking and non walking patients).

According to a further embodiment, the set of stored data represents the fluidity of movement of the patient.

The detection of the On and Off state of a patient is more accurate when the patient is walking and the set of stored data corresponds to patients which are in On or Off state and also walking, since changes in the fluidity of movement, related to the patient being in On or Off state, are easier to detect and represent with a model.

According to further embodiment, the method further comprises obtaining the model derived from a set of stored data.

According to a specific embodiment, the obtaining of the model comprises:
Obtaining a second set of data from the set of stored data referred to patients in On state and patients in Off state, said second set comprising a transformed portion of data related to the set of stored data, having the second set of data higher variance compared to the original portion of data from the set of stored data;
Obtaining a set of features from the obtained second set of data;
Obtaining the model by modifying a learning system using the obtained features.

Said second set of data may be a selection of the set of stored data modified in such a way that said selection, compared to the analogous selection of the set of stored data, has a higher variance. That is, if the set of stored data is a matrix A, the second set of data may be a matrix B which corresponds to the first N columns of matrix A but has a higher variance than the first N columns of matrix A.

According to an embodiment of the invention, the obtaining of a second set of data is performed by applying a Principal Component Analysis type algorithm to the set of stored data.

Other similar transformations may be performed on the set of stored data, such as specific embodiments of the Principal Component Analysis, for example Kernel PCA, Probabilistic PCA, etc.

According to a specific embodiment of the invention, the obtaining of the model, the learning is an SVM type classifier.

A learning system may be a classifier type system, and also other learning systems may be used such as the generally known as: k-nearest neibourghours, neural networks, Hidden Harkov models or Gaussian mixture models.

According to a second aspect of the invention, a method for predicting the onset of an On and Off state of a Parkinson patient is provided, the method comprising:
Obtaining inertial data from a patient;
Verifying if the patient is bound to enter in an On or Off state within the next predetermined period of time, by using a transformation of the obtained inertial data which uses a model derived from a set of stored data referred to patients in an onset of an On state and patients in an onset of an Off state.

According to a preferred embodiment, the verification of if the patient is in entering in an On or Off state is performed when the patient is walking.

According to a third aspect of the invention, a digital detector for detecting the On and Off states of a Parkinson patient is provided, comprising an input data port suitable for obtaining inertial data from a patient; computing means for verifying if the patient is in an On or Off state, by using a transformation of the obtained inertial data which uses a model derived from a set of stored data referred to patients in On state and patients in Off state; and an output port suitable for outputting a detection signal of an On or Off state of the patient.

According to a preferred embodiment, the digital detector further comprises computing storing means for storing at least one model derived from a set of stored data referred to patients in On state and patients in Off state.

According to a further aspect of the invention, a digital detector for predicting the onset On and Off states of a Parkinson patient is provided, comprising an input data port suitable for obtaining inertial data from a patient; computing means for verifying if the patient is bound to enter in an On or Off state within the next predetermined period of time, by using a transformation of the obtained inertial data which uses a model derived from a set of stored data referred to patients in an onset of an On state and patients in an onset of an Off state; and an output port suitable for outputting a prediction signal of the patient entering in an On state or the patient entering in an Off state.

According to a preferred embodiment, the digital detector further comprises computing storing means for storing at least one model derived from a set of stored data referred to patients in an onset of an On state and patients in an onset of an Off state.

According to a preferred embodiment of the invention, a device for injecting a pharmaceutical compound in a Parkinson patient is provided, comprising at least one movement sensor, an infusion pump for injecting a pharmaceutical compound, a digital detector for detecting the On and Off states of a Parkinson patient, and a computing means for determining the amount of pharmaceutical compound to be injected to the patient by the infusion pump, wherein said computing means determines the amount of compound to be injected based on the detection of said device for detecting the On and Off states.

According to a preferred embodiment of the invention, a device for injecting a pharmaceutical compound in a Parkinson patient is provided, comprising at least one movement sensor, an infusion pump for injecting a pharmaceutical compound, a digital detector for predicting the onset of an On and Off states of a Parkinson patient according to claim 12, and a computing means for determining the amount of pharmaceutical compound to be injected to the patient by the infusion pump, wherein said computing means determines the amount of compound to be injected based on the detection of said detector for predicting the onset of an On and Off states.

This way, by using this method a detection and/or prediction of the entry of the patient in an On or Off state may be detected, and a proper treatment while being in the state or before entering to one of said states may be performed, saving time in the treatment and shortening the duration of the effects of the disease.

According to a preferred embodiment of the invention, a computer program product is provided, comprising program instructions for causing a computer to perform the method for detecting the On and Off states of a Parkinson patient, the method comprising:
Obtaining inertial data from a patient;
Verifying if the patient is in an On or Off state, by using a transformation of the obtained inertial data which uses a model derived from a set of stored data referred to patients in On state and patients in Off state.

According to a preferred embodiment of the invention, a computer-readable storage medium is provided, including the computer program product comprising program instructions for causing a computer to perform the method for detecting the On and Off states of a Parkinson patient.

According to a preferred embodiment of the invention, a computer program product is provided, comprising program instructions for causing a computer to perform the method for predicting the onset of an On and Off state of a Parkinson patient, the method comprising:
Obtaining inertial data from a patient;
Verifying if the patient is bound to enter in an On or Off state within the next predetermined period of time, by using a transformation of the obtained inertial data which uses a model derived from a set of stored data referred to patients in an onset of an On state and patients in an onset of an Off state.

According to a preferred embodiment of the invention, a computer-readable storage medium is provided including the computer program product comprising program instructions for causing a computer to perform the method for predicting the onset of an On and Off state of a Parkinson patient.

It has to be understood that in all the above described systems, all of the described means may be embodied either in a computer program module or in a computer system corresponding to each means, or any combination of both. Also, several means may be comprised in the same module of a computer program or the same computer system.

### BRIEF DESCRIPTION OF THE DRAWINGS

An embodiment of the present invention will be described in the following, only by way of non-limiting example, with reference to the appended drawings, in which:

FIG. 1 is a graphical representation of three acceleration signals from a sensor movement, according to a preferred embodiment of the invention;

FIG. 2 is a further graphical representation of three acceleration signals from a sensor movement, according to a preferred embodiment of the invention;

FIG. 3 is a further graphical representation of three acceleration signals from a sensor movement, according to a preferred embodiment of the invention;

FIGS. 4.1, 4.2 and 4.3 are graphical representations of three pairs of acceleration signals related to On and Off state of a patient, according to a preferred embodiment of the invention.

### DESCRIPTION OF A PREFERRED EMBODIMENT

According to this preferred embodiment, a device is provided wherein the detection of the On and Off state of a Parkinson patient is performed only while the patient is in movement, and more specifically, when he or she is walking, and therefore, the detection of said movement is necessary.

Said detector is connected to a movement sensor, which is more specifically, an accelerometer, which outputs three signals corresponding to the three accelerations, one for each spatial dimension.

For the use of the detector, a previous obtaining of the model should be performed, and for doing that, several methods for obtaining the model have to be established. Said methods may be performed by a computing means which use digital ports for obtaining signals from the movement sensor. Alternatively, the movement sensor may also comprise a computing means in itself being programmable, and therefore the method may be performed by said computing means

More specifically, the different embodiments of the invention are different depending in which method for obtaining the model is used, being the methods the following:

### 1) Obtaining a Model by Obtaining the Velocity of the March of the Patient and Establishing a General Threshold of Velocity or a Specific One Depending on the Patient (Age, Normal Marching Velocity, Other Diseases Besides Parkinson, Etc.).

The detection of the velocity of march is performed by identifying in a signal from a movement sensor (3 acceleration values, from the three spatial coordinates X, Y and Z) the beginning and the ending of a step from a certain event (bearing in mind the mechanical characteristics of the walking of the person). From the acceleration values of the three dimensions (X, Y and Z) found in a step, a regression model is obtained (Epsilon support vector regression) from which the velocity of the step may be predicted from statistics applied to any acceleration value. For example, an applied statistic may be the mean of the module of the three acceleration signals, mean of the absolute values of the increases in the acceleration modules or mean of the frontal acceleration.

Furthermore, according to this specific embodiment, an optimal threshold would be a velocity of approximately between 30-40 cm/seg.

### 2) Obtaining the Model by Detecting the Length of the Step and Establishing a General Threshold of Length or a Specific One Depending on the Patient

The obtaining of said model is performed in a similar way as in the obtaining of 1), changing the statistic and therefore the regression model.

3) Obtaining a Model by Obtaining a Set of Characteristics of the Signal, which are not Represented Directly by any Biomechanical Parameter, but Associated Statistically to an On and Off State.

Certain statistical values may be derived from the raw data of the signal from the movement sensor, which may be useful to detect and/or predict the entering to an On or Off state. For example, the value of the entropy of the signal may be associated with an On and Off state of the patient.

4) Obtaining of the Model by Obtaining a Model which is a Learning System in the Form of a Classifying Machine.

By obtaining a learning system in the form of a classifying machine it is possible to obtain a different model for each patient, depending on his/her characteristics. Therefore, if the data used for obtaining the model is referred to a single patient, the model will only be useful for the patient whose data was used to obtain it. Said data from the patient is obtained through previous experimentation.

More specifically, the method for obtaining a model by obtaining a learning system in the form of a classifying machine comprises:
Obtaining a first set of data from a movement sensor, while the patient is in On state and walking;

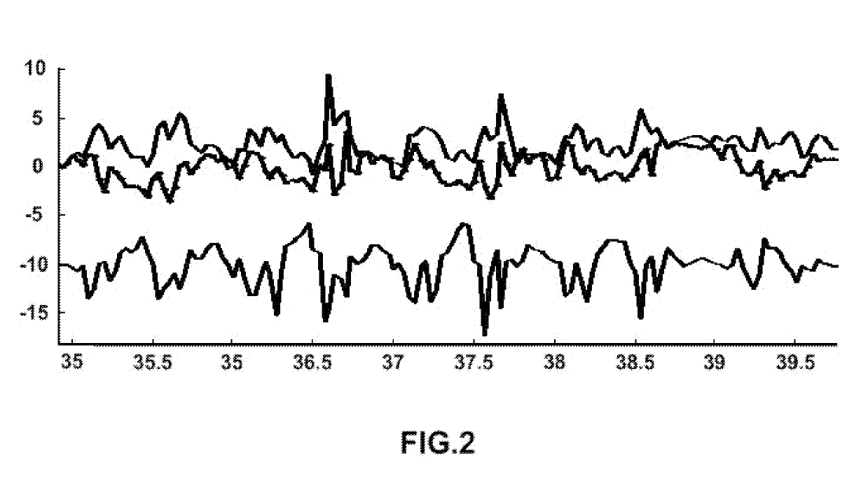

This is shown through FIG. 2, wherein the three acceleration values are graphically depicted (in m/s2) against time.
Obtaining a second set of data from a movement sensor, while the patient is in Off state and walking (seconds);

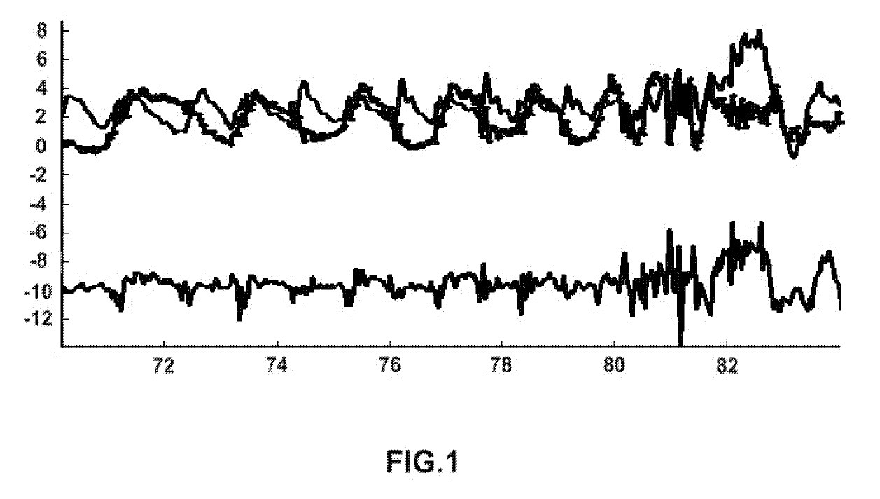

This is shown through FIG. 1, wherein the three acceleration values are graphically depicted (in m/s2) against time (seconds).
Obtaining subsets of data from the obtained first and second sets of data, with a length “x” (preferrably, “x” may be 30), said subset comprising consecutive data from the 3 accelerations of the signal from the movement sensor. The subset of data comprises, more specifically, the module of each acceleration data;
Obtaining a matrix (named M hereinafter) of “b” rows and “x” columns, containing the first set of data and the second set of data, wherein the rows 1 to “a” contain the subsets of data obtained from the first set of data (corresponding to On state), and rows “a+1” to “b” contain the subsets of data obtained from the second set of data (corresponding to Off state);
Applying the PCA (Principal Component Analysis) transformation. PCA is mathematically defined as an orthogonal linear transformation that transforms the data to a new coordinate system such that the greatest variance by any projection of the data comes to lie on the first coordinate (called the first principal component), the second greatest variance on the second coordinate, and so on. PCA is theoretically the optimum transform for given data in least square terms.

More specifically, in this case, the applying of PCA to matrix M returns two matrixes:
M matrix with its reference system change to that which maximizes the variance. Therefore, another matris M′ is obtained of “b” rows and “x” columns wherein the first column is the one with more variance and the last one is the one with less variance. Note that in this matrix, the first “a” rows still correspond to the On state, and the rest still correspond to the Off state.
A matrix Mₓ of x files and x columns which transforms a subset of data of x values (the above mentioned subset of data) to the new reference system. This matrix will be used in the method for detecting On and Off states.

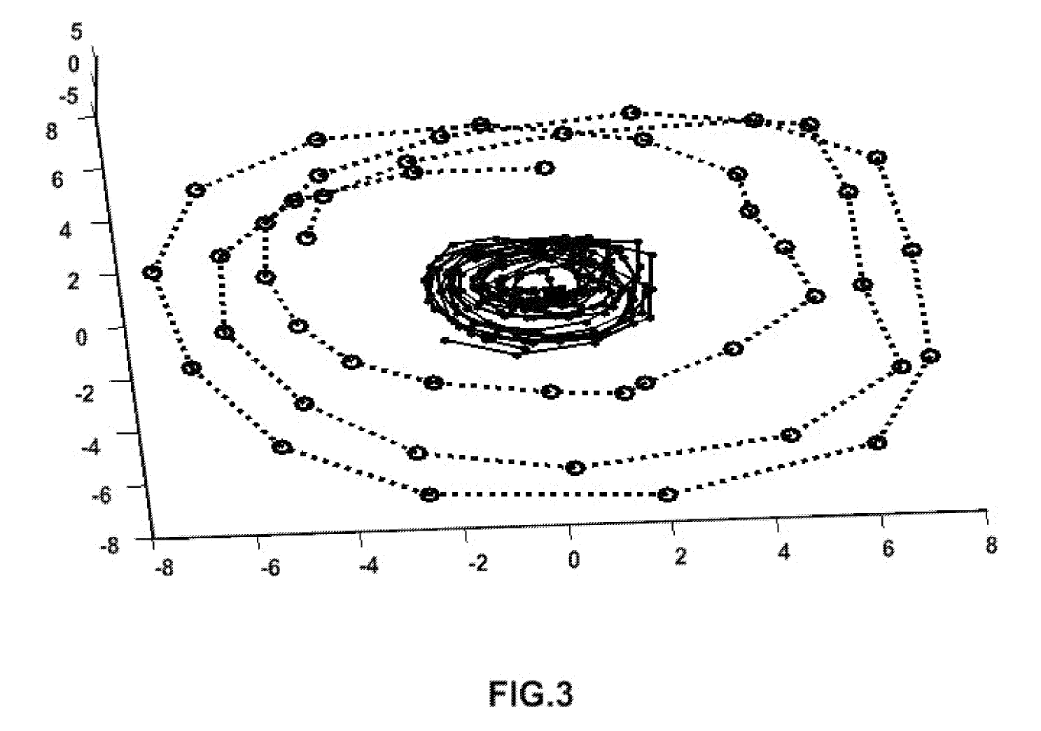

The data after the application of the PCA transformation can be seen in FIG. 3, wherein the three acceleration signals corresponding the three spatial dimensions of the acceleration, are depicted in an instant, each data united by a line with the next one. The external data ring corresponds to an On state of the patient and the center ring corresponds to an Off state of the patient.

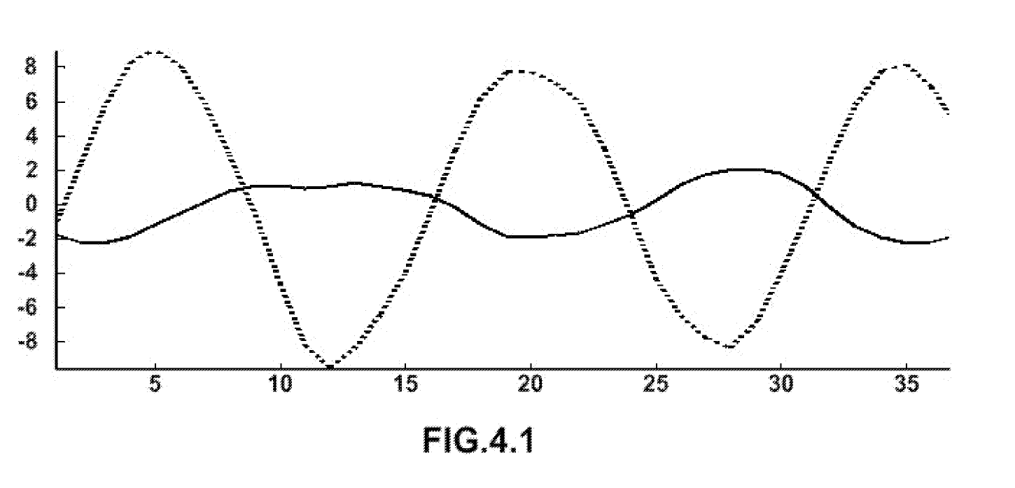

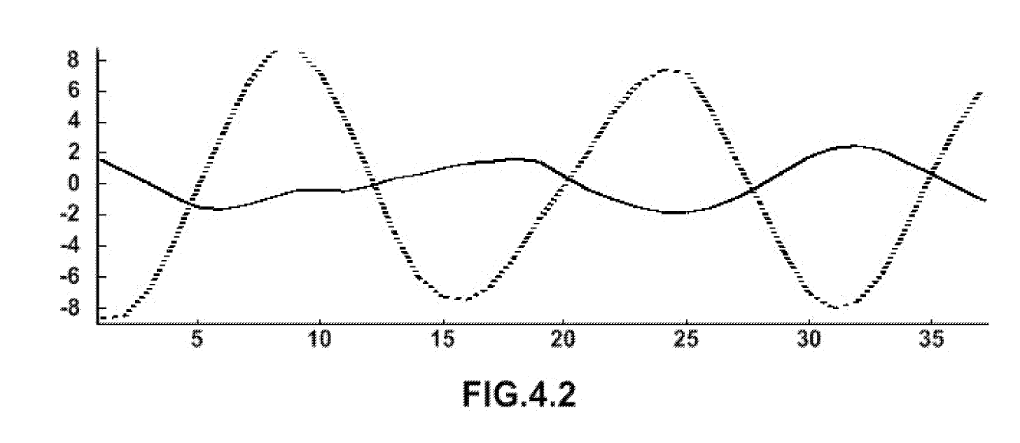

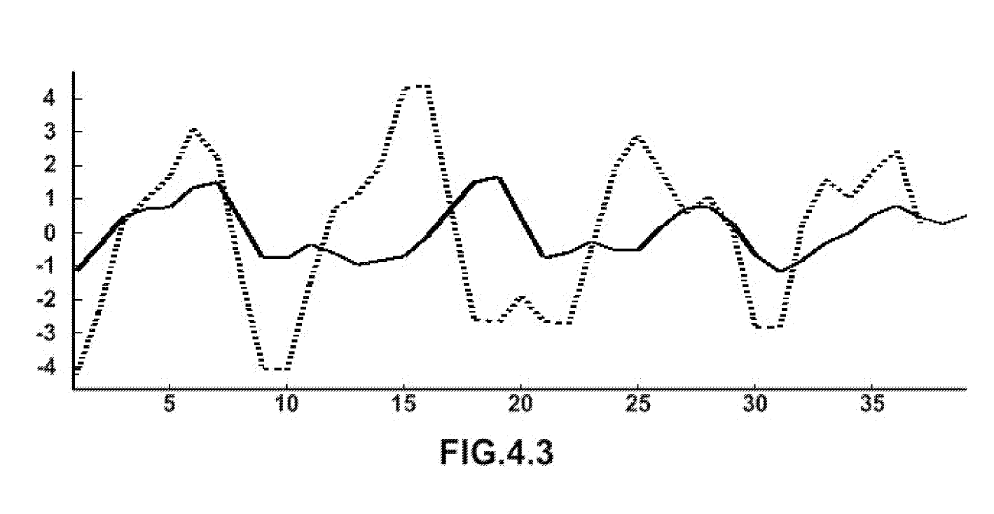

A further representation of the three acceleration signals after the application of the PCA transformation may be found in FIGS. 4.1, 4.2 and 4.3, corresponding to the 1st, 2nd and 3rd dimension respectively, and for each graphic, depicting the data corresponding to On state (discontinuous line) and Off state (continuous line).
Obtaining a sub-matrix M″ from the M′ matrix which contains the “m” first columns;
Obtaining one or more features from the obtained M″ sub-matrix, among the following:
Standard deviation of the “m” values;
Mean of the “m” values;
Maximum value of the “m” values;
Minimum value of the “m” values;
Range of values (maximum-minimum);
Mean value of the increases (if the “m” values are k₁, k₂, . . . kₘ, calculating the mean between (k₂−k₁), (k₃−k₂), . . . , (kₘ−kₘ₋₁));
Absolute mean value of the increases (if the “m” values are k₁, k₂, . . . kₘ, calculating the mean between abs(k₂−k₁), abs(k₃−k₂), . . . , abs(kₘ−kₘ₋₁));
Radius after changing to polar coordinates the value of the first two columns;
Radius after changing to polar coordinates the value of the first and third columns;
Radius after changing to polar coordinates the value of the second and third columns;
Sum of the “m” values;
Sum of the absolute values of the “m” values;
Inputting at least one of the 12 obtained features into an SVM (Support Vector Machine) type learning system.

Support vector machines (SVMs) are a set of related supervised learning methods used for classification and regression. In simple words, given a set of training examples, each marked as belonging to one of two categories, an SVM training algorithm builds a model that predicts whether a new example falls into one category or the other. Intuitively, an SVM model is a representation of the examples as points in space, mapped so that the examples of the separate categories are divided by a clear gap that is as wide as possible. New examples are then mapped into that same space and predicted to belong to a category based on which side of the gap they fall on.

In this case, since it is known which rows of the M″ matrix correspond to an On state and which to an Off state of the patient, it is possible to train the SVM with said features, obtaining at the end of the training a learning system or classifying machine in the form of an SVM which, given any 12 or less of said obtained features obtained from any data from a sensor movement, the classifying machine will output a signal which indicates that said data from a sensor movement corresponds to an On state patient or an Off state patient.

5) Obtaining of the Model by Obtaining a Model which is a Learning System in the Form of a Classifying Machine.

Also, as in case 4), this type of model may be obtained may be a general model useful for any kind of patient, or a different model for each patient, depending on his/her characteristics. Therefore, if the data used for obtaining the model is referred to a single patient, the model will only be useful for the patient whose data was used to obtain it. Said data from the patient is obtained through previous experimentation.

This obtaining is performed like method 4), but alternatively using windows of length “T” seconds and “t” values, which may fit more than “x” data within (that is, more than one subset of data of length “x”). More specifically, the method is exactly the same as in case 4) until the obtaining of the sub-matrix M″ from the M′ matrix which contains the “m” first columns (said obtaining included). Afterwards, the method is as follows:
Obtaining subsets of data of length x, and obtaining matrixes of all the possible subsets found within “T” seconds, the subsets having consecutive data. Each matrix is formed by x columns and z rows, and will correspond to On or Off states.
Multiplying each row of each matrix by the previously obtained Mₓ matrix, which results in the same matrixes with a change of reference system in its rows.
Obtaining a sub-matrix from each matrix which contains the “m” first columns of each original matrix.

Obtaining one or more features from all the obtained sub-matrixes, among the following:
Standard deviation of each column;
Mean of each column;
Maximum value of each column;
Minimum value of each column;
Range of values of each column;
Mean value of the increases of each column;
Absolute mean value of the increases of each column;
Mean radius after changing to polar coordinates the value of the first two columns;
Mean radius after changing to polar coordinates the value of the first and third columns;
Mean radius after changing to polar coordinates the value of the second and third columns;
Mean Angle after changing to polar coordinates the value of the first two columns;
Maximum radius after changing to polar coordinates the value of the first two columns;
Standard deviation of the radius after changing to polar coordinates the value of the first two columns;
Sum of the values of each column;
Sum of the absolute values of the values of each columns;

Similarly to the previous case, since it is known which rows of all the sub-matrixes correspond to an On state and which to an Off state of the patient, it is possible to train the SVM with said features, obtaining at the end of the training a learning system or classifying machine in the form of an SVM which, given any 12 or less of said obtained features obtained from any data from a sensor movement, the classifying machine will output a signal which indicates that said data from a sensor movement corresponds to an On state patient or an Off state patient.

After the obtaining of a model among the above preferred embodiments, the method for detecting the On and Off state of a Parkinson patient may be performed by a computing means. Said computing means may be embodied in a device which may be attached to the body of a patient and connected to at least one movement sensor. The movement sensor may be strategically positioned in the patient's body for an optimal obtaining of inertial data.

Alternatively, a movement sensor may comprise computing means which may be able to perform the method for detecting the On and Off states of a Parkinson patient.

Therefore, according to this preferred embodiment, the method for detecting the On and Off state of a Parkinson patient comprises:
Obtaining inertial data from a patient in the form of three acceleration signals from a sensor movement;
Verifying if the patient is in an On or Off state, by using a transformation of the obtained inertial data which uses a model chosen from any of the above mentioned models 1) to 5).

In a particular case, when using the model obtained by method 4), the detecting method may comprise:
Obtaining the last x values of the module of the accelerations;
Multiplying the vector comprising the x values with the previously obtained matrix Mₓ in 4), thus obtaining the same vector with a change of coordinate references;
Selecting the m first values of the overall x values;
Calculating the previously described features in 4);
Inputting the features to the obtained SVM in 4), which will output a signal indicating whether the obtained inertial data corresponds to a patient in an On state or to a patient in an Off state.

Alternatively, and more specifically, when using the model obtained by method 5), the detecting method may comprise:
Obtaining the window of t values (corresponding to T seconds) of the module of the accelerations;
Obtaining a matrix comprising all the possible subsets of data of “x” length within the window of t values. The obtained matrix has x columns and z rows.
Multiplying each row of the matrix by the previously obtained Mₓ matrix, therefore changing the reference system of each row.
Obtaining a sub-matrix from the resulting matrix of the multiplication, the sub-matrix comprising the first m columns.
Calculating the previously described features in 5);
Inputting the features to the obtained SVM in 5), which will output a signal indicating whether the obtained inertial data corresponds to a patient in an On state or to a patient in an Off state.

Although the present invention has been described in detail for purpose of illustration, it is understood that such detail is solely for that purpose, and variations can be made therein by those skilled in the art without departing from the scope of the invention.

Thus, while the preferred embodiments of the methods and of the systems and/or devices have been described in reference to the environment in which they were developed, they are merely illustrative of the principles of the invention. Other embodiments and configurations may be devised without departing from the scope of the appended claims.

Further, although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the processes according to the invention. The carrier may be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal, which may be conveyed via electrical or optical cable or by radio or other means.

When the program is embodied in a signal that may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

1. A method for detecting the On and Off states of a Parkinson patient, the method comprising:
Obtaining inertial data from a patient;
Verifying if the patient is in an On or Off state, by using a transformation of the obtained inertial data which uses a model derived from a set of stored data referred to patients in On state and patients in Off state.

2. A method for detecting the On and Off states according to claim 1, wherein the verification of if the patient is in an On or Off state is performed when the patient is moving.

3. A method for detecting the On and Off states according to claim 1, wherein the set of stored data represents the fluidity of movement of the patient.

4. A method for detecting the On and Off states according to claim 1, further comprising obtaining the model derived from a set of stored data.

5. A method according to claim 4, wherein the obtaining of the model comprises:
Obtaining a second set of data from the set of stored data referred to patients in On state and patients in Off state, said second set comprising a transformed portion of data related to the set of stored data, having the second set of data higher variance compared to the original portion of data from the set of stored data;
Obtaining a set of features from the obtained second set of data;
Obtaining the model by modifying a learning system using the obtained features.

6. A method according to claim 5, wherein the obtaining of a second set of data is performed by applying a Principal Component Analysis type algorithm to the set of stored data.

7. A method according to claim 5, wherein in the obtaining of the model, the learning system is an SVM type classifier.

8. A method for predicting the onset of an On and Off state of a Parkinson patient, the method comprising:
Obtaining inertial data from a patient;
Verifying if the patient is bound to enter in an On or Off state within the next predetermined period of time, by using a transformation of the obtained inertial data which uses a model derived from a set of stored data referred to patients in an onset of an On state and patients in an onset of an Off state.

9. A method for predicting the onset of an On and Off state, according to claim 8, wherein the verification of if the patient is in entering in an On or Off state is performed when the patient is moving.

10. Digital detector for detecting the On and Off states of a Parkinson patient, comprising an input data port suitable for obtaining inertial data from a patient; computing means for verifying if the patient is in an On or Off state, by using a transformation of the obtained inertial data which uses a model derived from a set of stored data referred to patients in On state and patients in Off state; and an output port suitable for outputting a detection signal of an On or Off state of the patient.

11. A digital detector according to claim 10, further comprising computing storing means for storing at least one model derived from a set of stored data referred to patients in On state and patients in Off state.

12. A digital detector for predicting the onset of an On and Off states of a Parkinson patient, comprising an input data port suitable for obtaining inertial data from a patient; computing means for verifying if the patient is bound to enter in an On or Off state within the next predetermined period of time, by using a transformation of the obtained inertial data which uses a model derived from a set of stored data referred to patients in an onset of an On state and patients in an onset of an Off state; and an output port suitable for outputting a prediction signal of the patient entering in an On state or the patient entering in an Off state.

13. A digital detector according to claim 12, further comprising computing storing means for storing at least one model derived from a set of stored data referred to patients in an onset of an On state and patients in an onset of an Off state.

14. A device for injecting a pharmaceutical compound in a Parkinson patient, comprising at least one movement sensor, an infusion pump for injecting a pharmaceutical compound, a digital detector for detecting the On and Off states of a Parkinson patient according to claim 10, and a computing means for determining the amount of pharmaceutical compound to be injected to the patient by the infusion pump, wherein said computing means determines the amount of compound to be injected based on the detection of said device for detecting the On and Off states.

15. A device for injecting a pharmaceutical compound in a Parkinson patient, comprising at least one movement sensor, an infusion pump for injecting a pharmaceutical compound, a digital detector for predicting the onset of an On and Off states of a Parkinson patient according to claim 12, and a computing means for determining the amount of pharmaceutical compound to be injected to the patient by the infusion pump, wherein said computing means determines the amount of compound to be injected based on the detection of said detector for predicting the onset of an On and Off states.

16. A computer program product comprising program instructions for causing a computer to perform the method for detecting the On and Off states of a Parkinson patient, the method comprising:
Obtaining inertial data from a patient;
Verifying if the patient is in an On or Off state, by using a transformation of the obtained inertial data which uses a model derived from a set of stored data referred to patients in On state and patients in Off state.

17. A computer-readable storage medium including the computer program product according to claim 16.

18. A computer program product comprising program instructions for causing a computer to perform the method for predicting the onset of an On and Off state of a Parkinson patient, the method comprising:
Obtaining inertial data from a patient;
Verifying if the patient is bound to enter in an On or Off state within the next predetermined period of time, by using a transformation of the obtained inertial data which uses a model derived from a set of stored data referred to patients in an onset of an On state and patients in an onset of an Off state.

19. A computer-readable storage medium including the computer program product according to claim 18.
